(19) United States
(12) Patent Application Publication
(10) Pub. No.: US 2026/0139605 A1
(43) Pub. Date: May 21, 2026

(54) SELF-POWERED TELEMETRY PACKAGE

(71) Applicant: RTX Corporation, Farmington, CT (US)

(72) Inventors: Eli Warren, Bend, OR (US); Matthew Christopher Moller, Wethersfield, CT (US)

(21) Appl. No.: 18/955,543

(22) Filed: Nov. 21, 2024

(51) Int. Cl. F01D 15/10; F01D 21/00

(52) U.S. Cl. CPC F01D 15/10; F01D 21/003; F05D 2220/764; F05D 2220/768

(57) ABSTRACT

A system for providing powered device operation on a rotating mechanism comprises static hardware configured to remain in a fixed position and rotating hardware configured to rotate about a central axis. Power generation circuitry associated with the static hardware and the rotating hardware is configured to generate a DC power signal on the rotating hardware and output the DC power signal. A powered device located on the rotating hardware is configured to receive the DC power signal and perform a powered operation on the rotating hardware.

### TECHNICAL FIELD

This disclosure relates generally to a powered telemetry package. More specifically, this disclosure relates to a powered telemetry package located on a rotating component.

### BACKGROUND

Gas turbine engine telemetry packages are used for communicating sensor measurements such as strain, temperature, pressure, etc. from locations on rotating hardware (i.e., blades, rotors) within the gas turbine engine to static data reduction/storage equipment using radio transmitters that are located on the rotating hardware for transmission to receivers on the static side with the reduction/storage equipment. Alternatively, signals from the transmitter of the telemetry package can be transmitted between the rotating hardware and the static hardware using induction techniques via separate coils located on the rotating hardware and static hardware. The rotating subsystem device is usually powered by either battery packs or may also use induction techniques to transmit power to the rotating subsystem via coils on the rotating hardware and static hardware. When using battery packages, testing options severely limit the length of time to collect data and adds significant weight to the rotating hardware of the gas turbine engine. The use of induction techniques to transmit power from the static hardware to the rotating hardware provides a power transmission system with increased complexity and limits the type of testing that can be done. Due to the complex nature of the induction powered system and the need for an external power source to provide the power for provision to the telemetry package on the rotating hardware, the system is normally limited to ground tests and special flight tests. Furthermore, the efficiency of induction power systems greatly increases the size of the hardware necessary to provide sufficient power to telemetry packages on the rotating hardware. Thus, the battery-powered or induction based power techniques are feasible for use in powering telemetry devices on rotating hardware of gas turbine engines in test stands but present problems for in-flight use. In order to use a telemetry package on an asset on-wing or in-flight, some major concessions must be made. These concessions make it a very infrequent occurrence for development test and contribute to it not being feasible for production assets. The induction-powered package is very inefficient and would use a lot of power from the airframe. The battery-powered option is efficient (already DC power), but it is heavy—the weight is added to the rotating hardware and has a limited time of use.

### SUMMARY

This disclosure relates to a powered device located on rotating hardware of a device such as a gas turbine engine.

In some examples, a system provides powered device operation on a rotating mechanism. The system also includes static hardware configured to remain in a fixed position, rotating hardware configured to rotate about a central axis, power generation circuitry associated with the static hardware and the rotating hardware configured to generate a DC power signal on the rotating hardware and output the DC power signal and a powered device located on the rotating hardware and configured to receive the DC power signal and perform a powered operation on the rotating hardware.

Any single one or any combination of the following features may be used with the examples above. The power generation circuitry further may include at least one magnet located on the static hardware in a fixed position, the magnets configured to provide a magnetic field, at least one coil located on the rotating hardware, where the at least one coil is configured to generate an AC power signal responsive to the at least one coil passing through the magnetic field of the at least one magnet and DC power generation circuitry configured to generate the DC power signal responsive to the AC power signal. The DC power generation circuitry further may include a rectifier circuit connected to an output of the at least one coil and configured to receive the AC power signal and generate the DC power signal responsive thereto, a voltage regulator connected to the output of the rectifier circuit configured to provide a regulated voltage signal as the DC power signal and a filter capacitor connected to an input of the voltage regulator. The rectifier circuit further may include a bridge rectifier circuit. The rectifier circuit further may include a center tapped rectifier circuit. The powered device further may include a powered telemetry package configured to measure an operating parameter associated with the rotating hardware and transmit the measured operating parameter to a location associated with static hardware. The system may include a transmitter located on the rotating hardware and powered by the DC power signal, the transmitter configured to transmit signals from the transmitter and a receiver located on the static hardware for receiving the transmitted signals from the transmitter located on the rotating hardware.

In other examples, a system includes static hardware of a gas turbine engine configured to remain in a fixed position, rotating hardware of the gas turbine engine configured to rotate about a central axis, power generation circuitry associated with the static hardware of the gas turbine engine and the rotating hardware of the gas turbine engine and configured to generate a DC power signal on the rotating hardware of the gas turbine engine and output the DC power signal and a powered telemetry package located on the rotating hardware of the gas turbine engine and configured to receive the DC power signal, where the powered telemetry package is configured to measure an operating parameter associated with the rotating hardware of the gas turbine engine.

Any single one or any combination of the following features may be used with the examples above. The system where the power generation circuitry further may include at least one magnet located on the static hardware of the gas turbine engine in a fixed position, the magnets configured to provide a magnetic field, at least one coil located on the rotating hardware of the gas turbine engine, where the at least one coil is configured to generate an AC power signal responsive to the at least one coil passing through the magnetic field of the at least one magnet and DC power generation circuitry configured to generate the DC power signal responsive to the AC power signal. The DC power generation circuitry further may include a rectifier circuit connected to an output of the at least one coil and configured to receive the AC power signal and generate the DC power signal responsive thereto, a voltage regulator connected to the output of the rectifier circuit configured to provide a regulated voltage signal as the DC power signal and a filter capacitor connected to an input of the voltage regulator. The rectifier circuit further may include a bridge rectifier circuit. The rectifier circuit further may include a center tapped rectifier circuit. The powered telemetry package is further configured to transmit the measured operating parameter to a location associated with static hardware. The system may include a transmitter located on the rotating hardware of the gas turbine engine and configured to be powered by the DC power signal, the transmitter configured to transmit the measured operating parameter from the transmitter and a receiver located on the static hardware of the gas turbine engine and configured to receive the transmitted measured operating parameter from the transmitter located on the rotating hardware of the gas turbine engine.

In still other examples, a method provides powered device operation on a rotating mechanism. The method also includes locating at least one magnet on static hardware in a fixed position, the magnets configured to provide a magnetic field, rotating at least one coil located on rotating hardware through the magnetic field of the at least one magnet, generating an AC power signal responsive to the at least one coil passing through the magnetic field of the at least one magnet, generating a DC power signal responsive to the AC power signal using DC power generation circuitry, powering a powered device located on the rotating hardware using the DC power signal and performing a powered operation on the rotating hardware using the powered device.

Any single one or any combination of the following features may be used with the examples above. The step of generating the DC power signal further may include receiving the AC power signal at a rectifier circuit, rectifying the AC power signal to generate the DC power signal at the rectifier circuit and regulating the DC power signal using a voltage regulator. The step of rectifying further may include rectifying the AC power signal using a bridge rectifier circuit. The step of rectifying further may include rectifying the AC power signal using a center tapped rectifier circuit. The powered device further may include a powered telemetry package. The step of performing a powered operation further may include measuring an operating parameter associated with the rotating hardware, transmitting the measured operating parameter from the rotating hardware to a location associated with static hardware using a transmitter powered by the DC power signal and receiving the transmitted measured operating parameter at a receiver located on the static hardware.

Other technical features may be readily apparent to one skilled in the art from the following figures, descriptions, and claims.

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates a telemetry package for transmitting measurement data between rotating gas turbine engine hardware and static gas turbine engine hardware;

FIG. 2 illustrates a block diagram of a system for providing power to a powered devices on rotating hardware in conjunction with static hardware;

FIG. 3 illustrates a block diagram of a system for providing a powered telemetry package on rotating hardware of a gas turbine engine;

FIG. 4 illustrates a first embodiment of DC power generation circuitry for the systems of FIGS. 2 and 3; and

FIG. 5 illustrates a second embodiment of DC power generation circuitry for the systems of FIGS. 2 and 3.

### DETAILED DESCRIPTION

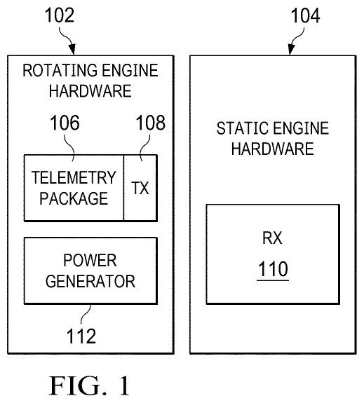

FIGS. 1 through 5, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

FIG. 1 illustrates telemetry package system for transmitting measured sensor data between rotating hardware 102 of the gas turbine engine and static hardware 104 of the gas turbine engine. The sensor data is measured by a telemetry package 106 located on the rotating hardware 102 of the gas turbine engine. The telemetry package 106 can measure information such as strain data, temperature data, pressure data, etc. with respect to various components located within the rotating hardware 102 of the gas turbine engine. With respect to a typical telemetry package a power of approximately 45 watts DC would be required. The voltage for a typical telemetry package would need to be a regulated 10 V. The telemetry package 106 may have a transmitter 108 associated therewith for transmitting the data to a receiver 110 using an RF signal or some other type of wireless transmission protocol. In order for the telemetry package 106 and associated transmitter 108 to transmit measured data from the rotating hardware 102 to the static hardware 104, the telemetry package 106 must be powered in order to obtain the associated system measurements and then transmit the measured data between the rotating hardware 102 and the static hardware 104. Power is provided to the telemetry package 106 and transmitter 108 via an integral power generator 112 located on the rotating hardware 102. This eliminates the need for batteries or induction connection to an external power source.

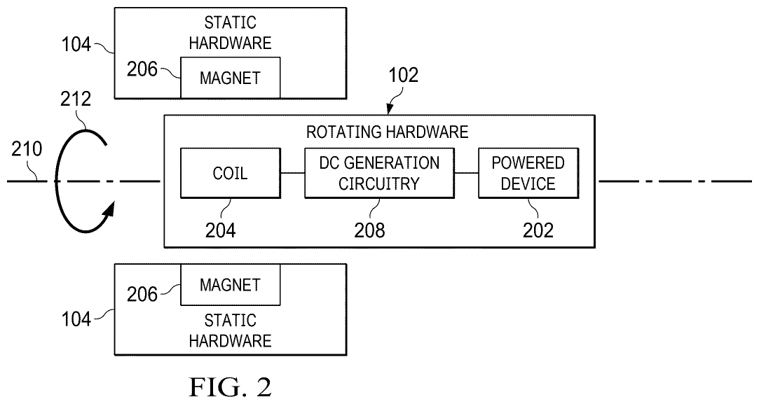

Referring now to FIG. 2, there is illustrated an implementation for providing a self-powered device associated with rotating hardware 102. While the above description with respect to FIG. 1, was made with respect to a telemetry package 106 associated with rotating hardware 102 of a gas turbine engine, it will be appreciated that systems described herein may be used for providing power to any powered device 202 that is located with rotating hardware 102 with respect to static hardware 104. The DC electrical power is provided from a coil 204, magnet 206 and DC generation circuitry 208. The magnet 206 is connected to the static hardware 104 and is maintained in a fixed position with respect to the coil 204. The coil 204 is connected to the rotating hardware 102 and is rotated by rotation of the rotating hardware 102 through a magnetic field provided by the fixed magnets 206 associated with the static hardware 104. While the above description has described the magnets 206 as being associated with the static hardware 104 in a preferred embodiment, the magnets 206 may also be implemented within a ground test unit that may be moved into place with respect to the rotating hardware 102 such that the coil 204 is rotated through a magnetic field provided by the electromagnets associated with the ground test unit. The use of electromagnets for creation of the magnetic field would allow for varying of the magnetic field strength and switching on and off the field is in the area.

Rotation of the coil or coils 204 through the magnetic field provided by the magnets 206 causes generation of an AC signal by the coils that is provided to the DC generation circuitry 208. Since the power is not transferred to the static hardware like in a common generator, the need for commutators is eliminated. The rotation of the rotating hardware 102 occurs generally about axis of rotation 210 in a direction of rotation shown generally at 212. While the direction of rotation 212 is illustrated in a particular direction with respect to FIG. 2, it will be appreciated that rotation in either direction about the axis of rotation 210 is possible. The DC generation circuitry 208 converts the received AC signal into a DC signal. The DC signal provided by the DC generation circuitry 208 is then used for providing power to the powered device 202. The powered device 202 can then perform whatever operations are provided by the powered device 202, and the entire power generation process occurs upon the rotating hardware 102 without requiring the transmission of power from an external source from the static hardware 104 to the rotating hardware 102 utilizing techniques previously described hereinabove.

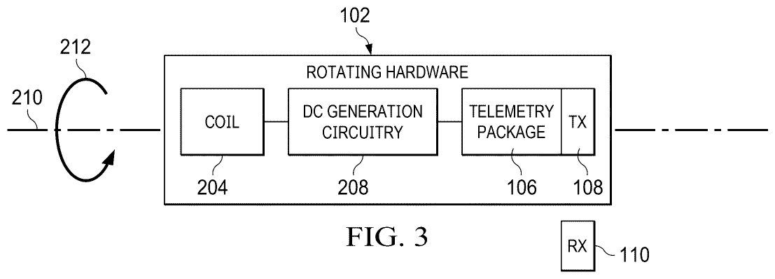

Referring now to FIG. 3, there is more particularly illustrated an implementation of a telemetry package 106 within a rotating hardware 102. In this case, the coil 204 and DC generation circuitry 208 generate a DC signal for the telemetry package 106 in a manner similar to that discussed hereinabove with respect to FIG. 2. The coil 204 is rotated through a magnetic field provided by magnets 206 associated with the static hardware 104 or other devices to provide an AC signal to the DC generation circuitry 208. The DC generation circuitry 208 converts the AC signal to a DC signal that is provided to power the telemetry package 106. The telemetry package 106 may then take various types of sensor measurements (strain, pressure, temperature, etc.) and these sensor measurements can then be transmitted by a transmitter 108 that is also powered by the DC signal from the DC generation circuitry 208 to wirelessly transmit the sensor measurements to a receiver 110 located off the rotating hardware 102 and associated with for example static hardware.

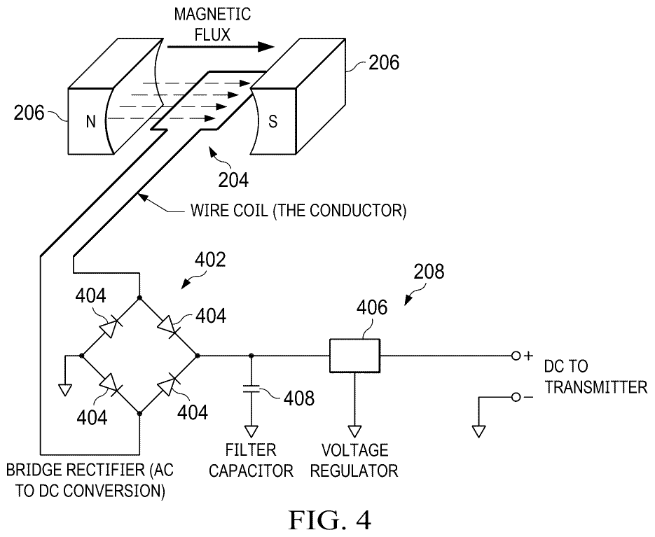

Referring now to FIG. 4, there is illustrated an embodiment of DC generation circuitry 208. The coil 204 is positioned to rotate through the magnetic field created by the magnets 206 that are associated with the static hardware 104 as described previously. The rotating coil 204 will generate an AC signal that is provided to a bridge rectifier 402. The bridge rectifier 402 consists of four interconnected diodes 404. The output of the bridge rectifier 402 is provided to the input of a voltage regulator 406 for regulating the voltage signal that is applied to the telemetry package 106, powered device 202 and/or transmitter 108. The output comprises a DC signal rather than the AC signal provided to the input of the bridge rectifier 402. Also connected to the input of the voltage regulator 406 is a filter capacitor 408 connected between the voltage regulator input and ground. The output of the voltage regulator 406 is used to provide a DC signal to the transmitter 108, powered device 202 or telemetry package 106.

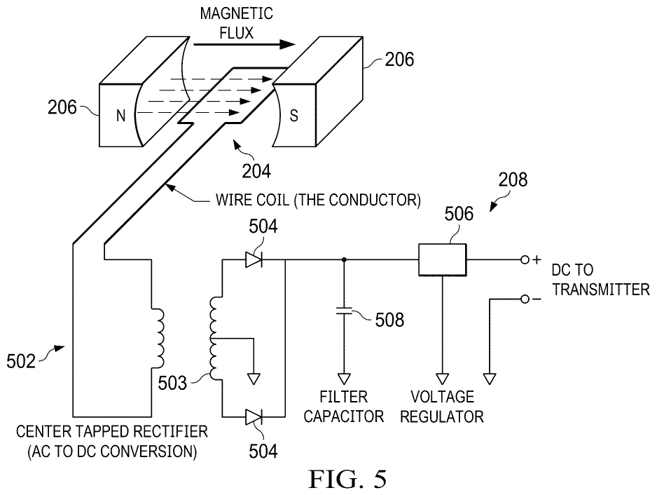

Referring now to FIG. 5, there is illustrated a further embodiment of DC generation circuitry 208. The coil 204 is positioned to rotate through the magnetic field created by the magnets 206 that are associated with the static hardware 104 as described previously. The rotating coil 204 will generate an AC signal that is provided to a center tapped rectifier 502. The center tapped rectifier 502 consists of center tapped transformer 503 having separate diodes 504 connected between the outputs of the center tapped transformer 503 and the input of a voltage regulator 506. The output comprises a DC signal rather than the AC signal provided to the input of the center tapped rectifier 502. The output of the center tapped rectifier 502 is provided to the input of a voltage regulator 506 for regulating the voltage signal that is applied to the telemetry package 106, powered device 202 and/or transmitter 108. Also connected to the input of the voltage regulator 506 is a filter capacitor 508 connected between the voltage regulator input and ground. The output of the voltage regulator 506 is used to provide a DC signal to the transmitter 108, powered device 202 or telemetry package 106.

Using the above-described system, a number of benefits are achieved over existing systems for powering telemetry packages or powered devices located upon rotating hardware. Compared to induction powered configurations, the system saves on the required extra hardware, reduces induction noise sources, and limits efficiency losses. When compared to battery-powered systems savings in the complexity of securing the batteries and the weight of the batteries depending upon the winding design used for implementing the generator on the rotor hardware. The above configuration allows for continuous operation of the telemetry package 106 and continuous measurements on the engine during a gas turbine engine test. The parasitic torque on the shaft is proportional to the needed power so there are few health and safety measurements and would not require large coils. The parasitic torque on the rotor would need to be figured into the mechanical operation of the rotor although for small packages with lo measurement counts this small. If parasitic torque was a concern during testing, the telemetry package 106 could be turned off for a portion of the test plan. Parasitic torque can be estimated with maximum power usage and speed of shaft based upon P=ωT.

In addition to the self-powered telemetry package and powered device packages described above, the idea of the generator implemented on a rotor hardware can be used for powering any number of applications on the rotating side of rotating machinery such as a spark on the rotating side of a rotary IC engine, variable pitched blade control and any rotating power needs for a hyper-electric drive.

It may be advantageous to set forth definitions of certain words and phrases used throughout this patent document. The term “couple” and its derivatives refer to any direct or indirect communication between two or more components, whether or not those components are in physical contact with one another. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

1. A system for providing powered device operation on a rotating mechanism, comprising:
static hardware configured to remain in a fixed position;
rotating hardware configured to rotate about a central axis;
power generation circuitry operatively coupled with the static hardware and the rotating hardware, the power generation circuitry configured to generate a DC power signal responsive to rotation of the rotating hardware and output the DC power signal, wherein the power generation circuitry further comprises:
at least one magnet located on the static hardware in a fixed position, the magnets configured to provide a magnetic field;
at least one coil located on the rotating hardware, wherein the at least one coil is configured to generate an AC power signal responsive to the at least one coil passing through the magnetic field of the at least one magnet; and
DC power generation circuitry configured to generate the DC power signal responsive to the AC power signal; and
a powered device located on the rotating hardware and configured to receive the DC power signal.

2. (canceled)

3. The system of claim 1, wherein the DC power generation circuitry further comprises:
a rectifier circuit connected to an output of the at least one coil and configured to receive the AC power signal and generate the DC power signal responsive thereto;
a voltage regulator connected to the output of the rectifier circuit configured to provide a regulated voltage signal as the DC power signal; and
a filter capacitor connected to an input of the voltage regulator.

4. The system of claim 3 wherein the rectifier circuit further comprises a bridge rectifier circuit.

5. The system of claim 3, wherein the rectifier circuit further comprises a center tapped rectifier circuit.

6. The system of claim 1, wherein the powered device further comprises a powered telementry apparatus configured to measure an operating parameter associated with the rotating hardware and transmit the measured operating parameter to a location associated with static hardware.

7. The system of claim 1 further comprising:
a transmitter located on the rotating hardware and powered by the DC power signal, the transmitter configured to transmit signals from the transmitter; and
a receiver located on the static hardware for receiving the transmitted signals from the transmitter located on the rotating hardware.

8. A system, comprising:
static hardware of a gas turbine engine configured to remain in a fixed position;
rotating hardware of the gas turbine engine configured to rotate about a central axis;
power generation circuitry operatively coupled with the static hardware of the gas turbine engine and the rotating hardware of the gas turbine engine, the power generation circuitry configured to generate a DC power signal responsive to rotation of the rotating hardware of the gas turbine engine and output the DC power signal; and
a powered telemetry apparatus located on the rotating hardware of the gas turbine engine and configured to receive the DC power signal, wherein the powered telemetry apparatus is configured to measure an operating parameter associated with the rotating hardware of the gas turbine engine.

9. The system of claim 8, wherein the power generation circuitry further comprises:
at least one magnet located on the static hardware of the gas turbine engine in a fixed position, the magnets configured to provide a magnetic field;
at least one coil located on the rotating hardware of the gas turbine engine, wherein the at least one coil is configured to generate an AC power signal responsive to the at least one coil passing through the magnetic field of the at least one magnet; and
DC power generation circuitry configured to generate the DC power signal responsive to the AC power signal.

10. The system of claim 9, wherein the DC power generation circuitry further comprises:
a rectifier circuit connected to an output of the at least one coil and configured to receive the AC power signal and generate the DC power signal responsive thereto;
a voltage regulator connected to the output of the rectifier circuit configured to provide a regulated voltage signal as the DC power signal; and
a filter capacitor connected to an input of the voltage regulator.

11. The system of claim 10 wherein the rectifier circuit further comprises a bridge rectifier circuit.

12. The system of claim 10, wherein the rectifier circuit further comprises a center tapped rectifier circuit.

13. The system of claim 8, wherein the powered telemetry apparatus is further configured to transmit the measured operating parameter to a location associated with static hardware.

14. The system of claim 8 further comprising:
a transmitter located on the rotating hardware of the gas turbine engine and configured to be powered by the DC power signal, the transmitter configured to transmit the measured operating parameter from the transmitter; and
a receiver located on the static hardware of the gas turbine engine and configured to receive the transmitted measured operating parameter from the transmitter located on the rotating hardware of the gas turbine engine.

15. A method for providing powered device operation on a rotating mechanism, the method comprising:
locating at least one magnet on static hardware in a fixed position, the at least one magnet configured to provide a magnetic field;
locating at least one coil on rotating hardware;
rotating the at least one coil located on the rotating hardware through the magnetic field of the at least one magnet;
generating an AC power signal responsive to the at least one coil passing through the magnetic field of the at least one magnet;
generating a DC power signal responsive to the AC power signal using DC power generation circuitry;
powering a powered device located on the rotating hardware using the DC power signal; and
performing an operation using the powered device.

16. The method of claim 15, wherein the step of generating the DC power signal further comprises:
receiving the AC power signal at a rectifier circuit;
rectifying the AC power signal to generate the DC power signal at the rectifier circuit; and
regulating the DC power signal using a voltage regulator.

17. The method of claim 16 wherein the step of rectifying further comprises rectifying the AC power signal using a bridge rectifier circuit.

18. The method of claim 16 wherein the step of rectifying further comprises rectifying the AC power signal using a center tapped rectifier circuit.

19. The method of claim 15, wherein the powered device further comprises a powered telemetry apparatus.

20. The method of claim 19, wherein the step of performing a powered operation further comprises:
measuring an operating parameter associated with the rotating hardware;
transmitting the measured operating parameter from the rotating hardware to a location associated with static hardware using a transmitter powered by the DC power signal; and
receiving the transmitted measured operating parameter at a receiver located on the static hardware.
